(19) United States
(12) Patent Application Publication
(10) Pub. No.: US 2006/0121748 A1
(43) Pub. Date: Jun. 8, 2006

(54) Coupling device for thin-film photovoltaic cells

(76) Inventor: Meindert Willem Brieko, St. Maarten (NL)

Correspondence Address: PILLSBURY WINTHROP SHAW PITTMAN LLP, 1650 TYSONS BOULEVARD, MCLEAN, VA, 22102, US

(21) Appl. No.: 10/541,060

(22) PCT Filed: Dec. 24, 2003
(86) PCT No.: PCT/NL03/00941

§ 371 Date: Jun. 29, 2005

(30) Foreign Application Priority Data
Jan. 24, 2003 (NL) 1022489

(51) Int. Cl. H01R 11/30

(52) U.S. Cl. 439/38

(57) ABSTRACT

Coupling device for electrical coupling of a first thin-film photovoltaic cell to a second thin-film photovoltaic cell, which coupling device comprises at least one magnetic pressing element for positioning an electrically conductive layer on, and in electrical contact with, respective co-acting edge zones of the first and the second cell for bringing the first and the second cell into electrical contact in the overlapping state of these edge zones.

The invention relates to a coupling device for electrical coupling of a first thin-film photovoltaic cell to a second thin-film photovoltaic cell.

A thin-film photovoltaic cell usually consists of a carrier foil, on one side of which is deposited a photoactive layer which is provided with conductors for transporting in a first direction charge carriers generated under incident light. The carrier foil is provided on its other side with an electrically conductive layer, or consists wholly of a conductive material, for the purpose of transporting charge carriers in a second direction opposed to the first direction.

The photoactive layer comprises for instance copper indium selenide (CuInSe₂, usually referred to as CIS), on which a pattern of aluminium (Al) conductors is arranged, which layer is deposited on a metal carrier foil, for instance of Titanium (Ti), wherein an intermediate layer of sodium fluoride (NaF) is preferably applied in order to enhance the adhesion of the CIS.

In another thin-film photovoltaic cell the photoactive layer comprises for instance amorphous silicon (Si) deposited on a metallized plastic carrier foil, for instance a foil of polyethylene (PET) which is provided on its underside with a conductive coating layer.

It is a problem of the known thin-film photovoltaic cells that they are mechanically vulnerable and, as a result thereof, are difficult to connect electrically in series. An electrical series connection is for instance realized using an aluminium strip between the aluminium conductors of a first cell and the titanium carrier foil of a second cell, this strip being fixed by ultrasonic welding. Because the adhesion between the photoactive layer and the carrier layer is impaired at some positions during welding, the welding often results in damage to the photovoltaic cells.

It is an object of the invention to provide a coupling device for electrical coupling of thin-film photovoltaic cells which does not result in damage to these cells.

It a further object to provide such a coupling device, using which thin-film photovoltaic cells can be coupled in efficient, rapid and reliable manner.

These objects are achieved with a coupling device of the type stated in the preamble, which according to the invention comprises at least one magnetic pressing element for positioning electrical contact means on, and in electrical contact with, at least a part of respectively the first and second cell.

In a first embodiment the contact means are provided by an electrical conductor, for instance by a strip of aluminium or copper foil, which is pressed by the magnetic pressing element onto electrical contact points for connecting of respectively the first and second cell.

In a subsequent embodiment the contact means are provided by an electrically conductive layer on respective co-acting edge zones of the first and the second cell for bringing about, in overlapping state of these edge zones, an electrical connection between the first and the second cell. The electrical coupling is herein effected by the direct mechanical contact between the first and second cell, without use having to be made of a strip-like conductor between the first and second cell.

In a practical advantageous embodiment, a coupling device according to the invention comprises two co-acting permanent magnetic pressing elements for receiving therebetween in mutual electrical contact at least a part of the first and second cell. Two cells partly overlapping each other are herein coupled both mechanically and electrically by clamping thereof along their overlapping part between the two permanent magnets.

In a further embodiment, the magnetic pressing elements comprise a layer of a permanent magnetic material on the respective co-acting edge zones of the first cell and the second cell.

In this embodiment the pressing elements are integrated with the cells for coupling and coupling of the cells comprises no more than the positioning of these cells with the co-acting edge zones in overlapping position.

In another embodiment the at least one magnetic pressing element comprises a layer of a permanent magnetic material on the first edge zone of the first cell, and the second cell is provided with a layer of a ferromagnetic material on the second edge zone.

In this latter embodiment the second edge zone of the second cell is for instance the edge zone of a carrier foil containing a ferromagnetic material.

The respective electrically conducting layers forming the contact means are preferably provided on the respective layers of the permanent magnetic and the ferromagnetic material. The layers of permanent magnetic material and ferromagnetic material thus bring about an optimal mechanical coupling, and the respective electrically conducting coating layers on these layers of permanent magnetic and ferromagnetic material bring about an optimal electrical contact between the first and second cell.

The permanent magnetic material is selected, subject to the conditions under which the photovoltaic cells for coupling are applied, from per se known materials, such as ceramic hard ferrites, neodymium-iron-boron, samarium-cobalt or aluminium-nickel-cobalt (“alnico”).

The ferromagnetic material is for instance selected from the group of materials comprising the elements iron (Fe), cobalt (Co), nickel (Ni), rare earths and alloys and compounds of one or more of these elements, the electrically conducting layer contains for instance gold (Au).

In a practical advantageous embodiment, the coupling device according to the invention is provided with locking means for locking two cells coupled to the coupling device against displacement in the direction of the plane of these cells, which locking means comprise for instance a locking pin of an insulating material extending through co-acting openings formed in the at least one pressing element and the first and second cell.

The invention will be elucidated hereinbelow on the basis of exemplary embodiments and with reference to the drawings.

In the drawings:

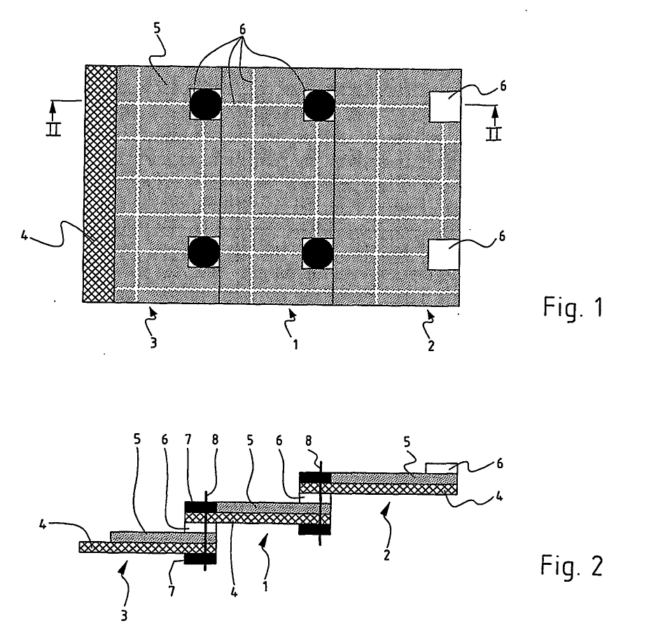

FIG. 1 shows a top view of three solar cells connected in series using permanent magnets according to a first embodiment of the invention,

FIG. 2 shows a view in cross-section through the solar cells shown in FIG. 1 along the line II-II,

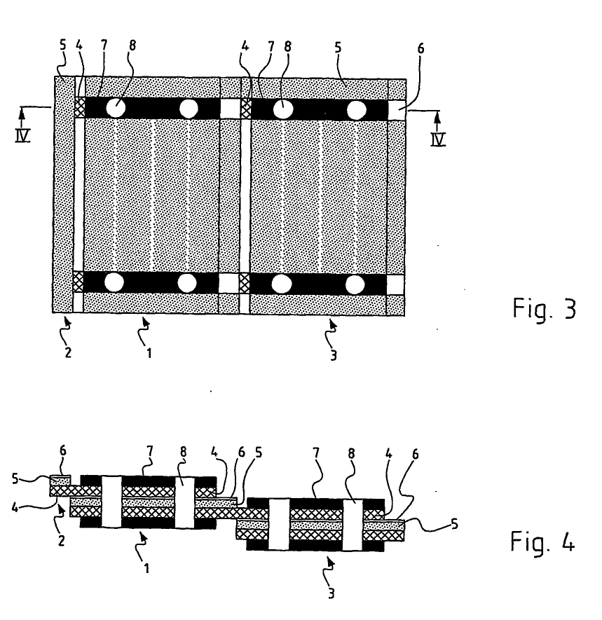

FIG. 3 shows a top view of three solar cells connected in series using permanent magnets according to a second embodiment of the invention, and

FIG. 4 shows a view in cross-section through the solar cells shown in FIG. 3 along the line IV-IV.

Corresponding components are designated in the figures with the same reference numerals.

FIGS. 1 and 2 show three solar cells 1, 2, 3 connected in series which each comprise a titanium foil 4 on which is deposited a photoactive layer 5 which is provided in each case with a pattern of metal conductors 6 for transporting charge carriers. Here the titanium foil 4 provides in each case for transport of charge carriers in opposing directions. Solar cells 1, 2, 3 are connected in series in that the titanium foil 4 of a cell 2 respectively 1 rests in each case along an edge zone on the metallization pattern 6 along an edge zone of a preceding cell 1 respectively 3, wherein pairs of co-acting permanent magnets 7 exert in each case a force below and above the edge zones of cells 3, 1 and 1, 2 for coupling which is perpendicular to the plane of the cells, and thus bring about a good electrical contact between the respective titanium foils 4 and metallization patterns 6. The thus coupled cells 1, 2, 3 are locked against displacement in a direction in the plane of the cells by locking pins 8 of an insulating plastic material, for instance Kapton®, a polyamide, which extend through close-fitting openings in magnets 7 and the coupled solar cells 1, 2, 3 perpendicularly of the plane of these cells 1, 2, 3.

FIGS. 3 and 4 show solar cells 3, 1, 2 (partially) which are connected in series in that the strips of the titanium foil 4 of a cell 2 respectively 1 rest in each case on an edge zone of the metallization pattern 6 of a subsequent cell 1 respectively 3, wherein pairs of co-acting permanent magnets 7 exert in each case a force below and above the edge zones of cells 3, 1 and 1, 2 for coupling which is perpendicular to the plane of the cells, and thus bring about a good electrical contact between the respective titanium foils 4 and metallization patterns 6. The thus coupled cells 1, 2, 3 are locked against displacement in a direction in the plane of the cells by locking pins 8 of Kapton® which extend through close-fitting openings in magnets 7 and the coupled solar cells 1, 2, 3 perpendicularly of the plane of these cells 1, 2, 3.

The figures have the purpose of elucidating the invention and provide a schematic and simplified representation of solar cells coupled according to the invention, wherein the ratios of the shown components do not correspond to reality. In coupled thin-film solar cells according to the invention, the layer thicknesses for a Ti carrier foil, an active layer and a metallization layer amount for instance to respectively 25 μm, 1 μm and 3 μm, a permanent magnet has a thickness and a diameter of respectively 1 mm and 5 mm and a plastic locking pin has a diameter of 2 mm.

The exemplary embodiments serve to elucidate the invention and can be supplemented within the scope of the inventive concept by a skilled person in the professional field. It is for instance possible according to the invention to lock coupled photovoltaic cells with an insulated metal screw or pin of titanium or molybdenum. The coupling device according to the invention is elucidated on the basis of an exemplary embodiment, wherein thin-film solar cells with a titanium carrier foil are coupled. It is pointed out that within the scope of the inventive concept the coupling device is equally applicable for coupling thin-film solar cells with a metallized plastic carrier foil.

It is emphasized that in the context of the present invention “thin-film photovoltaic cells” include all photovoltaic cells which have a thickness such that they are suitable for electrical coupling to a coupling device according to the invention. Examples of such photovoltaic cells are chalcogenide cells, in particular copper indium(gallium)selenide (CI(G)S) cells, cells with amorphous silicon, organic cells and dye-sensitized liquid cells.

1. Coupling device for electrical coupling of a first thin-film photovoltaic cell (1) to a second thin-film photovoltaic cell (2, 3), characterized in that it comprises at least one magnetic pressing element (7) for positioning electrical contact means on, and in electrical contact with, at least a part of respectively the first (1) and second cell (2, 3).

2. Coupling device as claimed in claim 1, characterized in that the contact means comprise an electrical conductor.

3. Coupling device as claimed in claim 1, characterized in that the contact means comprise an electrically conductive layer (6) on respective co-acting edge zones of the first (1) and the second cell (2, 3) for bringing the first (1) and the second cell (2, 3) into electrical contact in overlapping state of these edge zones.

4. Coupling device as claimed in claim 3, characterized in that it comprises two co-acting permanent magnetic pressing elements (7) for receiving therebetween in mutual electrical contact at least a part of the first (1) and second cell (2, 3).

5. Coupling device as claimed in claim 4, characterized in that the magnetic pressing elements comprise a layer of a permanent magnetic material on the respective co-acting edge zones of the first cell and the second cell.

6. Coupling device as claimed in claim 3, characterized in that the at least one magnetic pressing element comprises a layer of a permanent magnetic material on the first edge zone of the first cell, and the second cell is provided with a layer of a ferromagnetic material on the second edge zone.

7. Coupling device as claimed in claim 6, characterized in that the second edge zone of the second cell is the edge zone of a carrier foil containing a ferromagnetic material.

8. Coupling device as claimed in any of the claims 5-7, characterized in that the respective electrically conducting layers (6) are provided on the respective layers of the permanent magnetic and the ferromagnetic material.

9. Coupling device as claimed in any of the claims 6-8, characterized in that the ferromagnetic material is selected from the group of materials comprising iron (Fe), cobalt (Co) and nickel (Ni).

10. Coupling device as claimed in any of the claims 5-9, characterized in that the electrically conducting layer contains gold (Au).

11. Coupling device as claimed in any of the claims 1-10, characterized in that it is provided with locking means (8) for locking two cells (1, 2, 3) coupled to the coupling device against displacement in the direction of the plane of these cells.

12. Coupling device as claimed in claim 12, characterized in that the locking means comprise a locking pin (8) of an insulating material extending through co-acting openings formed in the at least one pressing element (7) and the first (1) and second cell (2, 3).
